(19) United States
(12) Patent Application Publication
(10) Pub. No.: US 2012/0244744 A1
(43) Pub. Date: Sep. 27, 2012

(54) STRUCTURE OF CONNECTOR

(76) Inventor: CHING-KUN HUANG, New Taipei City (TW)

(21) Appl. No.: 13/053,198

(22) Filed: Mar. 21, 2011

(51) Int. Cl. H01R 13/52

(52) U.S. Cl. 439/519

(57) ABSTRACT

A connector structure includes a coaxial cable coupler, which receives therein at least one positioning block. The positioning block has a surface against which a water seal pad is positioned. A conductive pin is arranged to extend through the positioning block and the water seal pad. As such, the arrangement of the water seal pad effectively prevents invasion of water and simplifies the assembling process to thereby reduce the assembling costs.

### TECHNICAL FIELD OF THE INVENTION

The present invention generally relates to a connector, and more particularly to an improved structure of connector that improves water resistance, prevents invasion of water, and employs a simple assembling process to thereby reduce the assembling costs thereof.

### DESCRIPTION OF THE PRIOR ART

A variety of connectors are available in the market, such as coaxial cable connectors, USB connectors, SD connectors, and T-flash connectors. Generally speaking, a connector functions to provide an electrical connection between electronic devices and/or cards to realize operations of data communication, transmission, and reading. Taking a coaxial cable connector as an example, information technology (IT) facilities, such as notebook computers and small electronic devices, for example household electrical appliances, often use various coaxial cable connectors to build up internal wiring connections. Coaxial cable connectors of this category often function to provide electrical connection to conductors or substrates of other cables.

A cable TV system or a shared TV antenna system comprises a primary connection cable that is connected to a distributor. The distributor supplies outputs to secondary cables that are connected to user terminals for receiving signals transmitted through the TV system. The primary cable comprises a coaxial cable having an end to which a coaxial cable connector is mounted for connection with the distributor.

The coaxial cable connector comprises a terminal for connection. In an attempt to combine a conductive pin for electrical conduction and a spring clamp set at a front end, a tool is used to deform a coupling portion between the two in order to realize secured coupling.

The conventional coaxial cable connector has the following drawbacks and disadvantages:

For use in a humid environment, to prevent invasion of water that often leads to deterioration of signal transmission, a water-proof substance is often applied to seal joint portions on opposite ends of a coupler member of the connector. This increases the number of assembling steps and raises the costs. These problems need to be improved.

### SUMMARY OF THE INVENTION

A primary objective of the present invention is to provide a coaxial cable terminal structure that is waterproof by adding a water seal pad and at least one positioning block, to thereby reduce steps and costs of assembling and improve water resistance performance.

To achieve the above objective and effectiveness, the present invention provides a structure that comprises a coaxial cable coupler. The coaxial cable coupler receives therein at least one positioning block. The positioning block has one side surface against which a resilient water seal pad is positioned. A conductive pin is arranged to extend through both the positioning block and the water seal pad. The conductive pin has an end forming a stop block. As such, when the coaxial cable coupler is positioned in a humid site, the water seal pad, due to the resiliency thereof, gets expanded, when put into the coaxial cable couple, to engage an inner wall of the coaxial cable coupler so as to realize a sealing effect and thus provide an optimum water resistance performance for the whole structure. With the above described arrangement, the problems of the conventional coaxial cable connectors that the process of application of water sealing resin is complicated, and thus leads to an increase of manufacturing costs can be overcome.

A second objective of the present invention is to provide a connector structure that comprises a coaxial cable coupler that receives therein an inner sleeve, which in turn receives therein a spring clamp. The spring clamp is coupled to an end of a conductive pin. The inner sleeve is fit into an outer tube. The outer tube receives therein the spring clamp and the conductive pin. Such an arrangement provides a simple process of assembling and also realizes effective water resistance for the coaxial cable coupler.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a preferred embodiment according to the present invention.

FIG. 2 is an exploded view of the preferred embodiment according to the present invention.

FIG. 3 is a cross-sectional view of the preferred embodiment according to the present invention.

FIG. 4 is perspective view illustrating combination of a spring clamp and a conductive pin according to the present invention.

FIG. 5 is a perspective view illustrating a first phase of inserting a water seal pad into a coaxial cable coupler according to the present invention.

FIG. 6 is a perspective view illustrating a second phase of inserting the water seal pad into the coaxial cable coupler according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

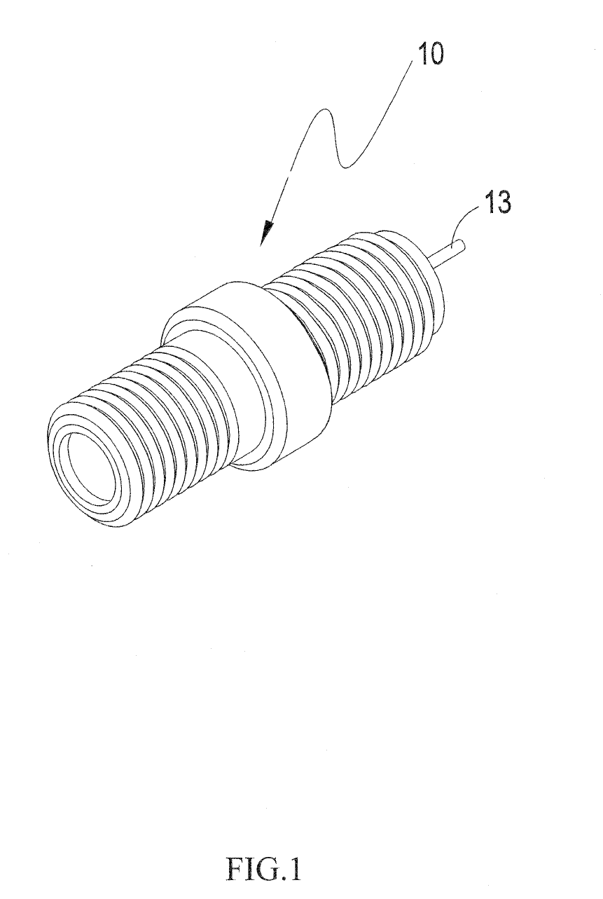

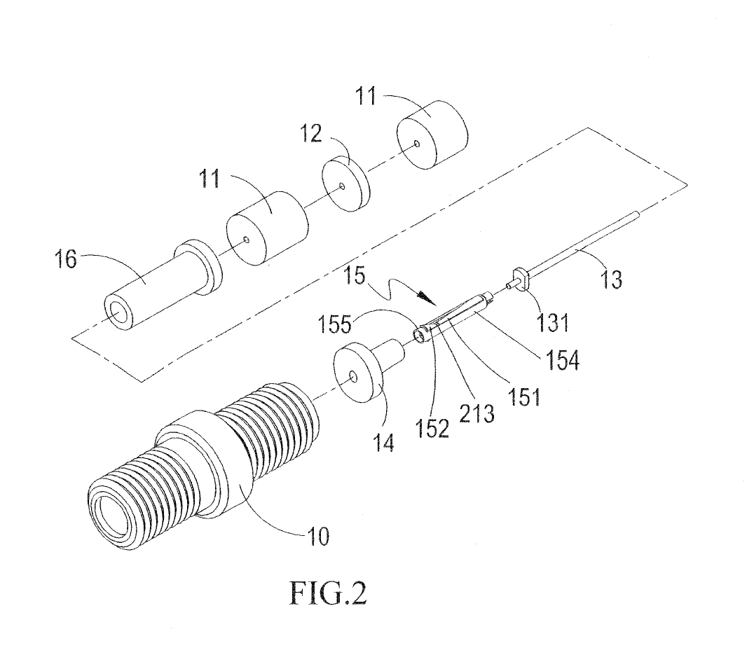

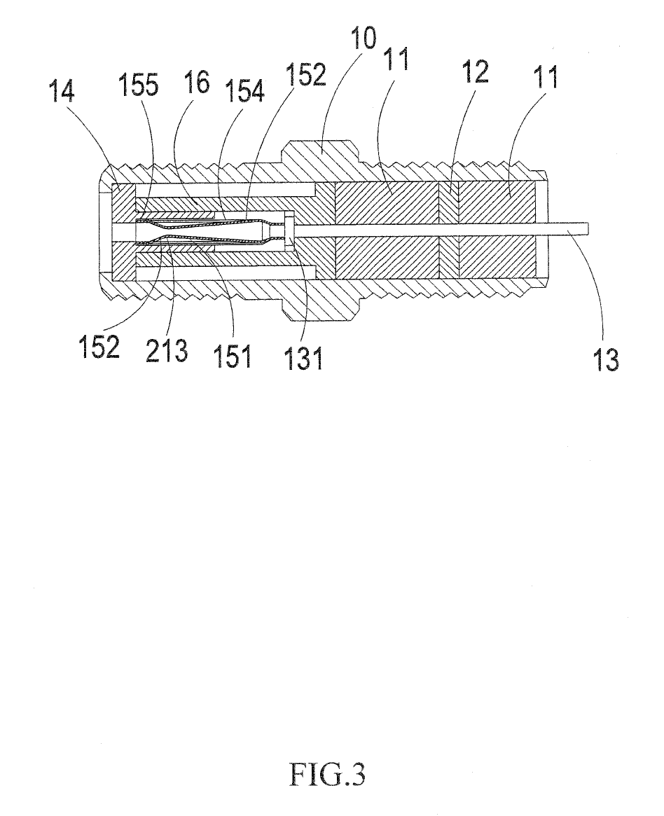

Referring to FIGS. 1, 2, and 3, which are a perspective view, an exploded view, and a cross-sectional view of a preferred embodiment according to the present invention, the drawings clearly show that the present invention comprises a coaxial cable coupler 10, which is hollow and receives therein a water seal pad 12 that is resilient, so as to realize a waterproof effect through the arrangement of the water seal pad 12.

The coaxial cable coupler 10 further receives therein a positioning block 11 and a conductive pin 13 extending through the positioning block 11 and the water seal pad 12. The conductive pin 13 has an end forming a stop block 131.

The coaxial cable coupler 10 further receives therein an inner sleeve 14, which in turn receives therein a spring clamp 15. The spring clamp 15 comprises at least two petals that are arranged on opposite sides of the spring clamp and extend toward an end of the spring clamp. Each of the petals is first bent inward to form a retention section 151. The retention section 151 has an end that is bent outward to form an engagement section 152. A clamping section 153 is thus defined between the retention section 151 and the engagement section 152. The spring clamp 15 comprises at least one support arm 154 that is formed to extend to the end of the spring clamp. Each support arm 154 has an end that forms a ring 155. The spring clamp 15 is coupled to an end of the conductive pin 13 and the inner sleeve 14 is then received into an outer tube 16. The outer tube 16 receives the spring clamp 15 and the conductive pin 13 to fit therein.

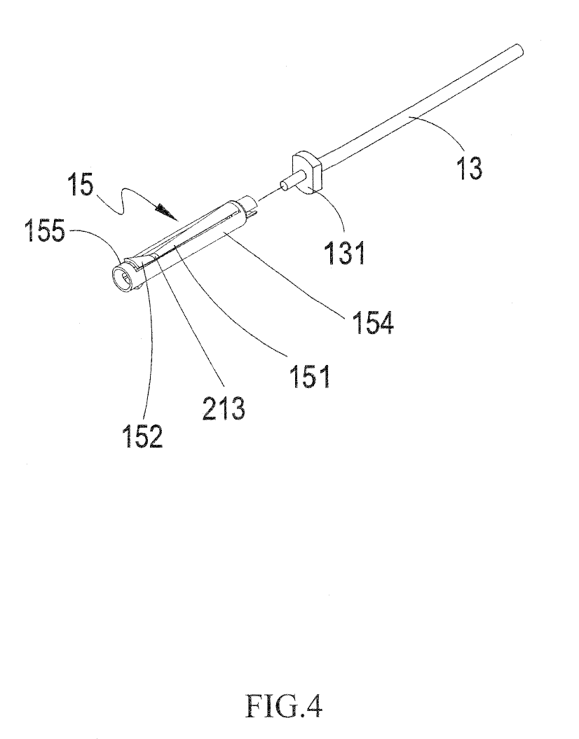

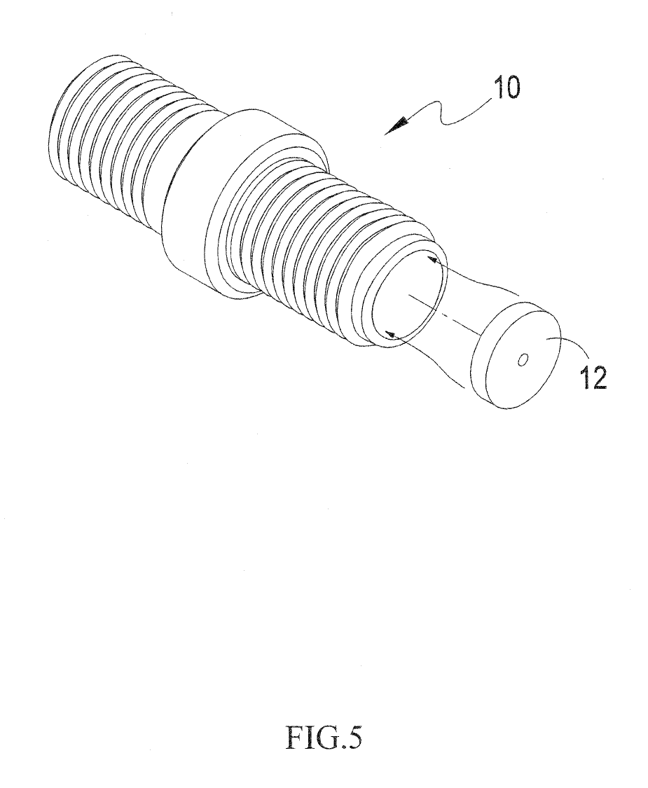

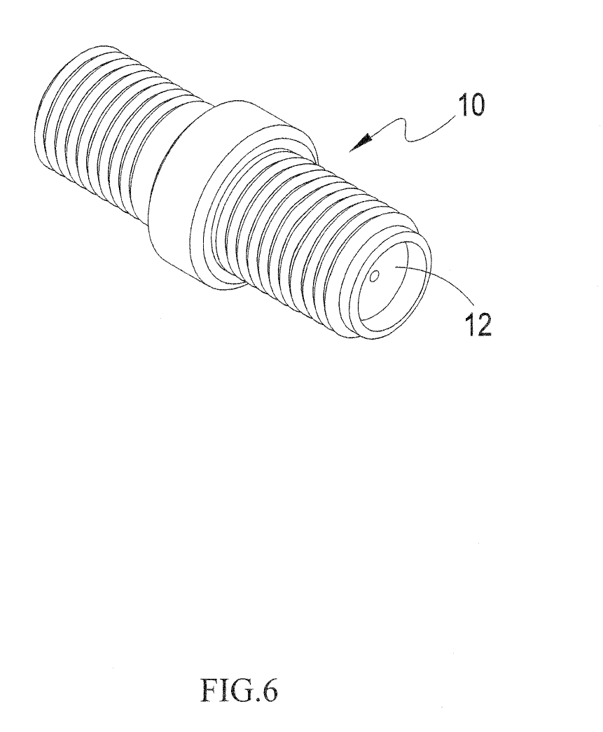

Referring to FIGS. 1-6, which are respectively a perspective view, an exploded view, and a cross-sectional view of the preferred embodiment of the present invention, a perspective view illustrating combination of the spring clamp and the conductive pin, and two perspective views sequentially illustrating insertion of the water seal pad into the coaxial cable coupler, these drawings clearly show that a transmission cable, when fit into the spring clamp 15, first engages the outward-bent engagement sections 152. A force is then applied to the transmission cable to force the transmission cable to get into the spring clamp 15, whereby the transmission cable is clamped by the clamping sections 153 to complete the coupling of the transmission cable for signal transmission. During this coupling process of the transmission cable, when the transmission cable is inserted into the spring clamp 15, the resiliency of the retention sections 151 forces the clamping sections 153 to tightly engage and thus clamp an outer surface of the transmission cable to thereby allow the transmission cable to be completely fit into the spring clamp 15.

Further, when the conductive pin 13 is set into the spring clamp 15, the stop block 131 of the conductive pin 13 facilitates positioning of the conductive pin 13 with respect to the spring clamp 15.

Further, the water seal pad 12 that is received in the coaxial cable coupler 10 is made of a resilient material. Once the assembly of the spring clamp 15 according to the present invention is completed, the water seal pad 12 is put into an end of the coaxial cable coupler 10. Due to the resiliency of the water seal pad 12, the water seal pad 12 may undergo forced deformation in order to be received in to the coaxial cable coupler 10. When being forced into the coaxial cable coupler 10, a circumference of the water seal pad 12 is in engagement with an inner circumferential wall of the coaxial cable coupler 10 to establish a sealed condition, which allows the present invention to provide a waterproof effect.

Thus, the connector structure according to the present invention provides the following feature that helps overcoming the drawbacks of the conventional devices:

The resiliency of the water seal pad 12 allows the water seal pad 12 to resiliently expand after being forcibly fit into the coaxial cable coupler 10 to tightly engage the inner circumferential surface of the coaxial cable coupler 10 for forming a sealed condition, thereby realizing a coaxial cable terminal structure that is water proof and reduces steps and costs of assembling, and also improve water resistance performance.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A connector structure comprising a coaxial cable coupler, the coaxial cable coupler receiving therein a water seal pad in such a way that the water seal pad has an outer circumference is set in engagement with an inner wall of the coaxial cable coupler, whereby a waterproof effect is realized through the water seal pad.

2. The connector structure according to claim 1, wherein the coaxial cable coupler receives therein a positioning block.

3. The connector structure according to claim 2, wherein the coaxial cable coupler receives therein a conductive pin that extends through the positioning block and the water seal pad.

4. The connector structure according to claim 1, wherein the coaxial cable coupler receives therein an inner sleeve, which receives therein a spring clamp, the spring clamp being coupled to an end of the conductive pin, the inner sleeve being fit into an outer tube, the outer tube receiving the spring clamp and the conductive pin to fit therein.

5. The connector structure according to claim 4, wherein the spring clamp comprises at least two petals that are arranged on opposite sides of the spring clamp and extend toward an end of the spring clamp, each of the petals being first bent inward to form a retention section, which has an end that is bent outward to form an engagement section, a clamping section being defined between the retention section 151 and the engagement section.

6. The connector structure according to claim 4, wherein the spring clamp comprises at least one support arm that is formed to extend to an end of the spring clamp, the support arm having an end that forms a ring.

7. The connector structure according to claim 1, wherein the conductive pin has an end forming a stop block.

8. The connector structure according to claim 1, wherein the water seal pad comprises a resilient pad.
